(19) United States
(12) Patent Application Publication
(10) Pub. No.: US 2017/0240708 A1
(43) Pub. Date: Aug. 24, 2017

(54) POLYSULFONE COPOLYMER WITH EXCELLENT HEAT RESISTANCE AND CHEMICAL RESISTANCE, AND METHOD FOR PREPARING SAME

(71) Applicant: SAMYANG CORPORATION, Seoul (KR)

(72) Inventors: Jong Kwan LIM, Chungcheongbuk-do (KR); Hyung Jin ROH, Daejeon (KR); Seong Hyen HEO, Busan (KR)

(73) Assignee: SAMYANG CORPORATION, Seoul (KR)

(21) Appl. No.: 15/504,530

(22) PCT Filed: Aug. 24, 2015
(86) PCT No.: PCT/KR2015/008808

§ 371 Date: Feb. 16, 2017

(30) Foreign Application Priority Data
Aug. 25, 2014 (KR) 10-2014-0110991
Jun. 3, 2015 (KR) 10-2015-0078373

(51) Int. Cl. C08G 75/23

(52) U.S. Cl. CPC C08G 75/23

(57) ABSTRACT

The present invention relates to a polysulfone copolymer with excellent heat resistance and chemical resistance, and a method for preparing the same and, more specifically, to a polysulfone copolymer and a method for preparing the same, wherein the polysulfone copolymer comprises, as repeat units, a sulfone-based compound, and an anhydrosugar alcohol, which is a biogenic material, and thus the polysulfone copolymer can solve a problem of an exhaustion of petroleum resources, which are limited resources; does not emit carbon dioxide regardless of the disposal after use, and thus is eco-friendly; and has significantly improved heat resistance and chemical resistance compared with existing polysulfone copolymers.

### FIELD

The present invention relates to a polysulfone copolymer having excellent chemical resistance and heat resistance and a method for preparing the same, and more specifically, a polysulfone copolymer which comprises sulfone-based compound and anhydrosugar alcohol which is a biogenic material as repeat units, and thus can solve the problem of exhaustion of petroleum resources which are limited resources; does not emit carbon dioxide when disposed after use, and thus is environmentally friendly; and has significantly improved heat resistance and chemical resistance as compared with conventional polysulfone copolymers; and a method for preparing the same.

### BACKGROUND ART

Hydrogenated sugar (also referred to as “sugar alcohol”) means a compound obtained by adding hydrogen to the reductive end group in sugar, and generally has a chemical formula of HOCH₂(CHOH)ₙCH₂OH wherein n is an integer of 2 to 5. According to the carbon number, hydrogenated sugar is classified into tetritol, pentitol, hexitol and heptitol (4, 5, 6 and 7 carbons, respectively). Among them, hexitol having 6 carbons includes sorbitol, mannitol, iditol, galactitol, etc. and in particular, sorbitol and mannitol are very useful materials.

Anhydrosugar alcohol has a diol form with two hydroxyl groups in the molecule, and can be produced by using hexitol derived from starch (for example, Korean Patent No. 10-1079518 and Korean Laid-open Patent Publication No. 10-2012-0066904). Because anhydrosugar alcohol is an environmentally friendly material derived from recyclable natural resources, it has received much interest for a long time and researches on its production continue to proceed. Among such anhydrosugar alcohols, isosorbide produced from sorbitol has the widest industrial applicability at present.

Anhydrosugar alcohol can be used in various fields including treatment of heart and blood vessel diseases, patch adhesive, medicaments such as mouthwash etc., solvents for compositions in the cosmetics industry, emulsifiers in the food industry, etc. In addition, it can increase the glass transition temperature of polymer materials like polyester, PET, polycarbonate, polyurethane, epoxy resin, etc., and improve the strength of such materials. Furthermore, because anhydrosugar alcohol is an environmentally friendly material derived from natural resources, it is very useful in the plastics industry such as bioplastics and the like. It is also known that anhydrosugar alcohol can be used as an adhesive, environmentally friendly plasticizer, biodegradable polymer, and environmentally friendly solvent for water-soluble lacquer.

As such, anhydrosugar alcohol is receiving much interest because of its wide applicability, and the level of practical industrial application thereof is increasing.

Polysulfone is one of the compounds which are effectively used as substances for electric insulation materials requiring heat resistance, various molding materials requiring dimensional stability/chemical resistance, and membranes. Polysulfone is generally produced by using raw materials derived from petroleum resources. However, because of the concern about exhaustion of the limited petroleum resources, it is required to provide polysulfone using raw materials obtained from biomass resources such as plants, etc. In addition, from the viewpoint of concern about climate change caused by global warming due to increase of emitted amount of carbon dioxide and accumulation thereof, it is required to develop polysulfone using plant-derived, carbon-neutral monomers as raw materials, in order not to emit carbon dioxide when disposed after use.

For instance, Korean Laid-open Patent Publication No. 10-2014-0054765 discloses a microfilter membrane comprising a polysulfone-based polymer, and a method for preparing the same. More concretely, it discloses that if a polysulfone-based polymer is used for preparing a microfilter membrane or an ultrafilter membrane, it is possible to obtain filter membranes having pores with suitably controlled shape and size on its surface or inside thereof. However, since the polysulfone-based polymer in this prior art is synthesized without using other alternative materials, it cannot suggest a solution to the recently issued environmental problem.

Accordingly, it is required to provide a polysulfone copolymer which comprises an alternative material, and thus can solve the problem of exhaustion of resources; does not emit carbon dioxide when disposed after use, and thus is environmentally friendly; and has improved heat resistance and chemical resistance.

### DETAILED DESCRIPTION OF THE INVENTION

### Technical Purpose

To resolve the problems of prior arts as explained above, the present invention has an object of providing a polysulfone copolymer which comprises sulfone-based compound and anhydrosugar alcohol which is a biogenic material as repeat units, and thus can solve the problem of exhaustion of petroleum resources which are limited resources; does not emit carbon dioxide when disposed after use, and thus is environmentally friendly; and has significantly improved heat resistance and chemical resistance as compared with conventional polysulfone copolymers; and a method for preparing the same.

### Technical Means

To achieve the above-stated object, the present invention provides a polysulfone copolymer comprising: repeat units derived from diol component comprising anhydrosugar alcohol; and repeat units derived from dihalogenated sulfone compound.

The other aspect of the present invention provides a method for preparing a polysulfone copolymer, comprising the steps of: (1) polymerizing diol component comprising anhydrosugar alcohol, and dihalogenated sulfone compound in the presence of alkali metal salt catalyst; (2) diluting the polymerization reaction product and removing halogenated product of alkali metal therefrom; and (3) precipitating the diluted polymerization reaction product and washing it.

Another aspect of the present invention provides a molded product manufactured by using the above polysulfone copolymer.

### Effect of the Invention

The polysulfone copolymer according to the present invention comprises sulfone-based compound and anhydrosugar alcohol which is a biogenic material as repeat units, and thus can solve the problem of exhaustion of petroleum resources which are limited resources; does not emit carbon dioxide when disposed after use, and thus is environmentally friendly; and has significantly improved heat resistance and chemical resistance as compared with conventional polysulfone copolymers, and thus can be used very suitably for resin processed articles such as membranes, etc.

### MODE OF CARRYING OUT THE INVENTION

The present invention is explained in more detail below.

The polysulfone copolymer of the present invention comprises: repeat units derived from diol component comprising anhydrosugar alcohol; and repeat units derived from dihalogenated sulfone compound.

The anhydrosugar alcohol means any material that is obtained by removing one or more water molecules from a compound, referred to as “hydrogenated sugar” or “sugar alcohol,” obtained by adding hydrogen to the reductive end group in sugar.

In the present invention, as the anhydrosugar alcohol, dianhydrohexitol—which is the dehydrated product of hexitol—can be preferably used, and more preferably, the anhydrosugar alcohol can be selected from the group consisting of isosorbide (1,6-dianhydrosorbitol), isomannide (1,6-dianhydromannitol), isoidide (1,6-dianhydroiditol) and mixtures thereof.

In the present invention, the diol component used in preparing the polysulfone copolymer may further comprise diol compound other than the anhydrosugar alcohol—for example, aromatic diol, alicyclic diol, aliphatic diol or mixture thereof—and may preferably further comprise aromatic diol.

As the aromatic diol, it is preferable to use aromatic diol selected from the group consisting of bisphenol A, 4,4′-dihydroxy-diphenyl sulfone, 4,4′-biphenol, hydroquinone, 4,4′-dihydroxy-diphenylether, 3-(4-hydroxyphenoxy)phenol, bis(4-hydroxyphenyl)sulfide and combinations thereof.

As the alicyclic diol, it is preferable to use alicyclic diol selected from the group consisting of 1,4-cyclohexanedimethanol, 1,3-cyclohexanedimethanol, 1,2-cyclohexanedimethanol, tricyclodecanedimethanol, adamantanediol, pentacyclopentadecanedimethanol and combinations thereof.

As the aliphatic diol, it is preferable to use aliphatic diol selected from the group consisting of ethyleneglycol, 1,3-propanediol, 1,2-propanediol, 1,4-butanediol, 1,3-butanediol, 1,2-butanediol, 1,5-heptanediol, 1,6-hexanediol, 1,4-cyclohexanedimethanol and combinations thereof.

Alicyclic diol compounds comprising a 5-membered ring structure or a 6-membered ring structure, which can be used in the present invention, may include an alicyclic diol compound represented by the following formula 1 or 2:

HOCH₂—R¹—CH₂OH [Formula 1]

HO—R²—OH [Formula 2]

In the above formulas 1 and 2, each of R¹ and R² independently represents a cycloalkyl group having 4 to 20 carbons, or a cycloalkoxy group having 6 to 20 carbons.

In the present invention, the diol component used in preparing the polysulfone copolymer may comprise, based on 100 mol % of the total diol component, preferably 0.1 to 99 mol % of the anhydrosugar alcohol, and 1 to 99.9 mol % of the diol compound other than the anhydrosugar alcohol (for example, aromatic diol, alicyclic diol and/or aliphatic diol); more preferably 1 to 90 mol % of the anhydrosugar alcohol, and 10 to 99 mol % of the diol compound other than the anhydrosugar alcohol; and still more preferably 5 to 80 mol % of the anhydrosugar alcohol, and 20 to 95 mol % of the diol compound other than the anhydrosugar alcohol. If the amount of the anhydrosugar alcohol in the total diol component is less than 0.1 mol % (i.e., if the the amount of the diol compound other than the anhydrosugar alcohol is greater than 99.9 mol %), there is little effect of improving heat resistance and chemical resistance of sulfone-based resin. If the amount of the anhydrosugar alcohol in the total diol component is greater than 99 mol %, it may be difficult to obtain the desired molecular weight.

In the present invention, as the dihalogenated sulfone compound used in preparing the polysulfone copolymer, dihalogenated diaryl sulfone may be used preferably. More specifically, the dihalogenated diaryl sulfone may be selected preferably from the group consisting of 4,4′-dichlorodiphenylsulfone, 4,4′-difluorodiphenylsulfone and combination thereof.

In the present invention, there is no special limitation to the amount ratio of the diol component and the dihalogenated sulfone compound used in preparing the polysulfone copolymer. Based on 100 moles of the total diol component, amount of the used dihalogenated sulfone compound may be preferably 50 moles to 300 moles; and more preferably 80 moles to 150 moles. If the amount of the used dihalogenated sulfone compound is too little or too much as compared with the amount of the total diol component used in preparing the polysulfone copolymer, the reaction between the diol component and the dihalogenated sulfone compound is not conducted properly, and thus it may be difficult to obtain the desired molecular weight.

In addition, dihalogenated compound other than the dihalogenated sulfone compound may be further used. Preferably, based on 100 parts by weight of the dihalogenated sulfone compound, 1 to 50 parts by weight of the dihalogenated compound other than the dihalogenated sulfone compound may be used. As such dihalogenated compound other than the dihalogenated sulfone compound, 1,4-dichlorobenzene, 1,4-difluorobenzene, bis(4-chlorophenyl)sulfide, di(4-fluorophenyl)sulfide or combination thereof may be used.

According to some embodiments of the present invention, although it is not especially limited thereto, the polysulfone copolymer of the present invention may comprise a structure represented by one of the following formulas 3 to 6 (wherein the part indicated by [ ] represents repeat unit):

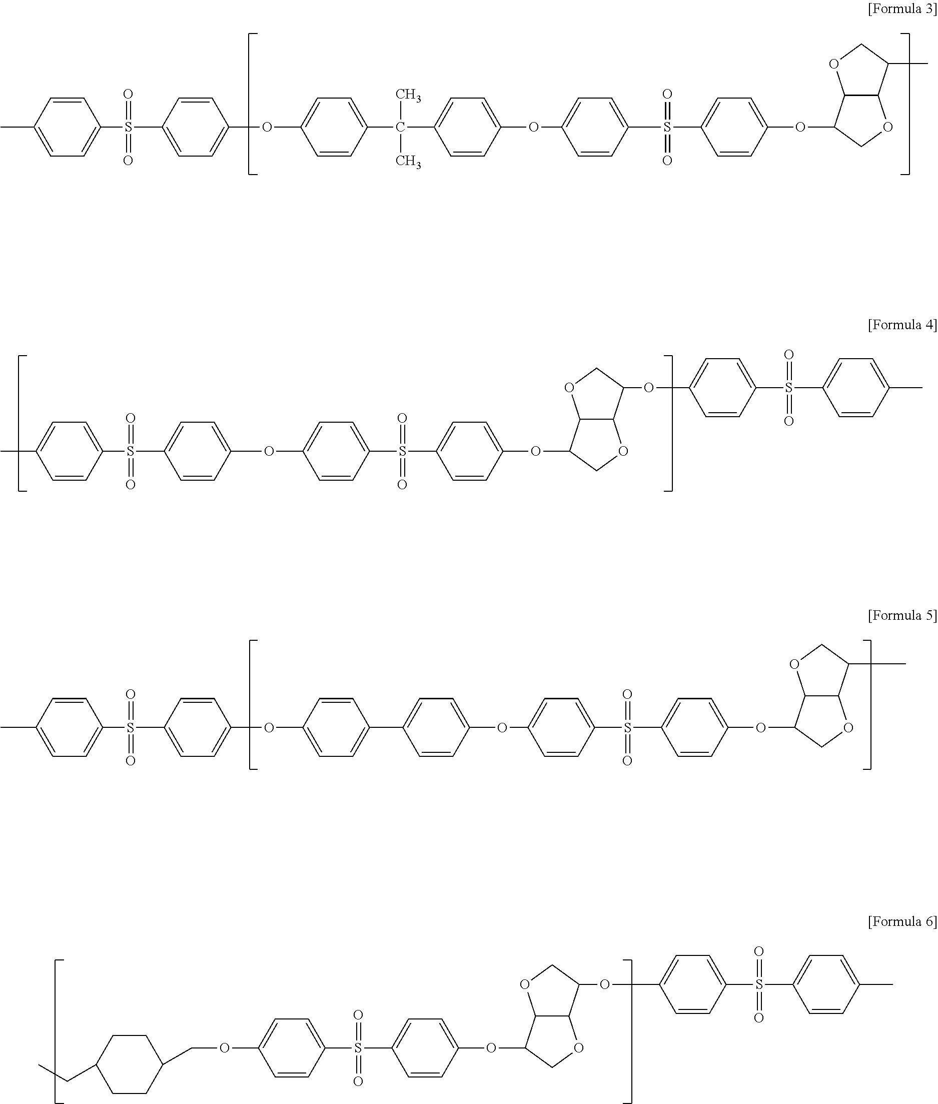

According to the other aspect of the present invention, provided is a method for preparing a polysulfone copolymer, comprising the steps of: (1) polymerizing diol component comprising anhydrosugar alcohol, and dihalogenated sulfone compound in the presence of alkali metal salt catalyst; (2) diluting the polymerization reaction product and removing halogenated product of alkali metal therefrom; and (3) precipitating the diluted polymerization reaction product and washing it.

The alkali metal salt catalyst may be preferably selected from the group consisting of potassium carbonate, sodium carbonate, sodium hydroxide, potassium hydroxide and mixtures thereof. There is no special limitation to the amount of catalyst used. However, if the amount of the used catalyst is too little, the reaction rate becomes slow, and if the amount of the used catalyst is too much, the residual catalyst may change the color of the product or the properties thereof may deteriorate. According to an embodiment of the present invention, for example, based on 100 moles of the diol component, the catalyst may be used in an amount of 80 to 300 moles, and more preferably, 100 to 130 moles.

The above polymerization reaction may be conducted, for example, at a temperature of 160 to 200° C. under atmospheric pressure for 5 to 10 hours in a reaction solvent such as N-methyl-2-pyrrolidone (NMP), dimethyl sulfoxide (DMSO), dimethyl acetamide (DMAc), dimethyl formamide (DMF), sulfolane, diphenyl sulfone (DPS), dimethyl sulfone (DMS), etc. a cosolvent such as chlorobenzene, tetrahydrofuran (THF), etc. or a solvent mixture thereof, but it is not limited thereto. After the polymerization is completed, the polysulfone copolymer of the present invention may be prepared by diluting the polymerization reaction product (wherein the dilution solvent may be the same as the polymerization reaction solvent) and from the diluted polymerization reaction product, removing halogenated product of alkali metal (salt of alkali metal from the alkali metal salt catalyst and halogen from the dihalogenated sulfone compound, for example, KCI) generated during the reaction by, for example, filtration through celite filter, or a decanter or a centrifuge using specific gravity difference; and precipitating the diluted and filtered polymerization reaction product in a solvent (for example, alcohol such as methanol, or water) and washing it with water or the like.

Since the polysulfone copolymer of the present invention as explained above comprises sulfone-based compound and anhydrosugar alcohol which is a biogenic material as repeat units, it can solve the problem of exhaustion of petroleum resources which are limited resources; does not emit carbon dioxide when disposed after use, and thus is environmentally friendly; and has significantly improved heat resistance and chemical resistance as compared with conventional polysulfone copolymers, and thus can be used very suitably for resin processed articles such as membranes, etc.

Therefore, according to another aspect of the present invention, a molded product, preferably a membrane, manufactured by using the polysulfone copolymer of the present invention is provided. As the molding process, solution spinning, casting (coating), extrusion, injection, etc. may be used, but it is not limited thereto. The field of application of the membrane provided according to the present invention may include R/O membrane for water treatment, electrolyte membrane for fuel cells, dialysis membrane for blood in medical use, electric/electronic connector, automobile parts, etc., but it is not limited thereto.

There is no special limitation in manufacturing a molded product such as membrane, etc. by using the polysulfone copolymer of the present invention, and any method generally used in manufacture of resin molded articles may be used as itself, or with proper modification.

The present invention is explained in more detail through the following Examples and Comparative Examples. However, the scope of the present invention is not limited thereby.

### EXAMPLES

### Preparation of Polysulfone Copolymer

### Example 1

Into a 3-necked 1 L flask equipped with an agitator, a thermometer and a condenser, isosorbide (ISB, 0.05 mole), 4,4′-dichlorodiphenyl sulfone (DCDPS, 1.0 mole), bisphenol A (BPA, 0.95 mole), potassium carbonate (1.1 mole), N-methyl-2-pyrrolidone (NMP, 10.1 mole) and chlorobenzene (1.11 mole) were fed. Under nitrogen purge, the reaction mixture was heated rapidly to the reaction temperature (160° C.), and it could be confirmed that chlorobenzene added as cosolvent effused the reaction byproduct H₂O azeotropically as the reaction time elapsed. After the reaction for 9 hours at the temperature of 192° C., the final reaction mixture changed to dark brown color, and the viscosity of the reaction mixture could be confirmed with the naked eye.

After cooling the final reaction mixture at room temperature, it was diluted with the preliminarily prepared solvent NMP. After filtering the diluted reaction mixture through celite, it was precipitated in methanol. After washing the precipitated product with distilled water and filtering, it was dried to obtain a polysulfone copolymer containing isosorbide (ISB).

### Example 2

Other than the fact that isosorbide (ISB, 0.1 mole), 4,4′-dichlorodiphenyl sulfone (DCDPS, 1.0 mole), bisphenol A (BPA, 0.9 mole), potassium carbonate (1.1 mole), N-methyl-2-pyrrolidone (NMP, 10.1 mole) and chlorobenzene (1.11 mole) were fed into a 3-necked 1 L flask equipped with an agitator, a thermometer and a condenser, the same method as Example 1 was carried out to obtain a polysulfone copolymer containing isosorbide (ISB) (10 mole %).

### Example 3

Other than the fact that isosorbide (ISB, 0.2 mole), 4,4′-dichlorodiphenyl sulfone (DCDPS, 1.0 mole), bisphenol A (BPA, 0.8 mole), potassium carbonate (1.1 mole), N-methyl-2-pyrrolidone (NMP, 10.1 mole) and chlorobenzene (1.11 mole) were fed into a 3-necked 1 L flask equipped with an agitator, a thermometer and a condenser, the same method as Example 1 was carried out to obtain a polysulfone copolymer containing isosorbide (ISB) (20 mole %).

### Example 4

Other than the fact that isosorbide (ISB, 0.4 mole), 4,4′-dichlorodiphenyl sulfone (DCDPS, 1.0 mole), bisphenol A (BPA, 0.6 mole), potassium carbonate (1.1 mole), N-methyl-2-pyrrolidone (NMP, 10.1 mole) and chlorobenzene (1.11 mole) were fed into a 3-necked 1 L flask equipped with an agitator, a thermometer and a condenser, the same method as Example 1 was carried out to obtain a polysulfone copolymer containing isosorbide (ISB) (40 mole %).

### Example 5

Other than the fact that isosorbide (ISB, 0.5 mole), 4,4′-dichlorodiphenyl sulfone (DCDPS, 1.0 mole), bisphenol A (BPA, 0.5 mole), potassium carbonate (1.1 mole), N-methyl-2-pyrrolidone (NMP, 10.1 mole) and chlorobenzene (1.11 mole) were fed into a 3-necked 1 L flask equipped with an agitator, a thermometer and a condenser, the same method as Example 1 was carried out to obtain a polysulfone copolymer containing isosorbide (ISB) (50 mole %).

### Example 6

Other than the fact that isosorbide (ISB, 0.7 mole), 4,4′-dichlorodiphenyl sulfone (DCDPS, 1.0 mole), bisphenol A (BPA, 0.3 mole), potassium carbonate (1.1 mole), N-methyl-2-pyrrolidone (NMP, 10.1 mole) and chlorobenzene (1.11 mole) were fed into a 3-necked 1 L flask equipped with an agitator, a thermometer and a condenser, the same method as Example 1 was carried out to obtain a polysulfone copolymer containing isosorbide (ISB) (70 mole %).

### Example 7

Other than the fact that isosorbide (ISB, 0.8 mole), 4,4′-dichlorodiphenyl sulfone (DCDPS, 1.0 mole), 1,4-cyclohexanedimethanol (CHDM, 0.2 mole), potassium carbonate (1.1 mole), N-methyl-2-pyrrolidone (NMP, 10.1 mole) and chlorobenzene (1.11 mole) were fed into a 3-necked 1 L flask equipped with an agitator, a thermometer and a condenser, the same method as Example 1 was carried out to obtain a polysulfone copolymer containing isosorbide (ISB).

### Example 8

Other than the fact that isosorbide (ISB, 0.2 mole), 4,4′-dichlorodiphenyl sulfone (DCDPS, 1.0 mole), 4,4′-dihydroxydiphenyl sulfone (DHDPS, 0.8 mole), potassium carbonate (1.1 mole), N-methyl-2-pyrrolidone (NMP, 10.1 mole) and chlorobenzene (1.11 mole) were fed into a 3-necked 1 L flask equipped with an agitator, a thermometer and a condenser, the same method as Example 1 was carried out to obtain a polysulfone copolymer containing isosorbide (ISB).

### Example 9

Other than the fact that isosorbide (ISB, 0.3 mole), 4,4′-dichlorodiphenyl sulfone (DCDPS, 1.0 mole), 4,4′-dihydroxydiphenyl sulfone (DHDPS, 0.4 mole), 1,4-cyclohexanedimethanol (CHDM, 0.3 mole), potassium carbonate (1.1 mole), N-methyl-2-pyrrolidone (NMP, 10.1 mole) and chlorobenzene (1.11 mole) were fed into a 3-necked 1 L flask equipped with an agitator, a thermometer and a condenser, the same method as Example 1 was carried out to obtain a polysulfone copolymer containing isosorbide (ISB).

### Example 10

Other than the fact that isosorbide (ISB, 0.2 mole), 4,4′-dichlorodiphenyl sulfone (DCDPS, 1.0 mole), 4,4′-biphenol (Biphenol, 0.8 mole), potassium carbonate (1.1 mole), N-methyl-2-pyrrolidone (NMP, 10.1 mole) and chlorobenzene (1.11 mole) were fed into a 3-necked 1 L flask equipped with an agitator, a thermometer and a condenser, the same method as Example 1 was carried out to obtain a polysulfone copolymer containing isosorbide (ISB).

### Example 11

Other than the fact that isosorbide (ISB, 0.3 mole), 4,4′-dichlorodiphenyl sulfone (DCDPS, 1.0 mole), 4,4′-biphenol (Biphenol, 0.4 mole), 1,4-cyclohexanedimethanol (CHDM, 0.3 mole), potassium carbonate (1.1 mole), N-methyl-2-pyrrolidone (NMP, 10.1 mole) and chlorobenzene (1.11 mole) were fed into a 3-necked 1 L flask equipped with an agitator, a thermometer and a condenser, the same method as Example 1 was carried out to obtain a polysulfone copolymer containing isosorbide (ISB).

TABLE 1
Molar ratios of the raw materials

| | | | | | Potassium | |
|---|---|---|---|---|---|---|
| | BPA | ISB | DCDPS | NMP | carbonate | Chlorobenzene |
| Example 1 | 0.95 | 0.05 | 1.0 | 10.1 | 1.1 | 1.11 |
| Example 2 | 0.9 | 0.1 | 1.0 | 10.1 | 1.1 | 1.11 |
| Example 3 | 0.8 | 0.2 | 1.0 | 10.1 | 1.1 | 1.11 |
| Example 4 | 0.6 | 0.4 | 1.0 | 10.1 | 1.1 | 1.11 |
| Example 5 | 0.5 | 0.5 | 1.0 | 10.1 | 1.1 | 1.11 |
| Example 6 | 0.3 | 0.7 | 1.0 | 10.1 | 1.1 | 1.11 |

TABLE 2
Molar ratios of the raw materials

| | | | | | | Potas- | |
|---|---|---|---|---|---|---|---|
| | | | | | | sium | Chloro- |
| | ISB | CHDM | DHDPS | DCDPS | NMP | carbonate | benzene |
| Exam- | 0.8 | 0.2 | 0 | 1.0 | 10.1 | 1.1 | 1.11 |
| ple 7 | | | | | | | |
| Exam- | 0.2 | 0 | 0.8 | 1.0 | 10.1 | 1.1 | 1.11 |
| ple 8 | | | | | | | |
| Exam- | 0.3 | 0.3 | 0.4 | 1.0 | 10.1 | 1.1 | 1.11 |
| ple 9 | | | | | | | |

TABLE 3
Molar ratios of the raw materials

| | | | | | | Potas- | |
|---|---|---|---|---|---|---|---|
| | | | | | | sium | |
| | | | | | | carbon- | Chloro- |
| | ISB | CHDM | Biphenol | DCDPS | NMP | ate | benzene |
| Exam- | 0.2 | 0 | 0.8 | 1.0 | 10.1 | 1.1 | 1.11 |
| ple 10 | | | | | | | |
| Exam- | 0.3 | 0.3 | 0.4 | 1.0 | 10.1 | 1.1 | 1.11 |
| ple 11 | | | | | | | |

### Comparative Example 1

Other than the fact that 4,4′-dichlorodiphenyl sulfone (DCDPS, 1.0 mole), bisphenol A (BPA, 1.0 mole), potassium carbonate (1.1 mole), N-methyl-2-pyrrolidone (NMP, 10.1 mole) and chlorobenzene (1.11 mole) were fed into a 3-necked 1 L flask equipped with an agitator, a thermometer and a condenser, the same method as Example 1 was carried out to obtain a polysulfone copolymer.

### Comparative Example 2

A PSU product for membrane (SOLVAY3500 manufactured by Solvay)

For each of the copolymers prepared in the above Examples and Comparative Examples, the glass transition temperature (heat resistance), chemical resistance, weight average molecular weight and molecular weight distribution were measured and shown in the following Tables 4 to 6.

Glass Transition Temperature (Tg)

The glass transition temperature of the copolymer was measured by using Diamond DSC (Differential Scanning calorimetry) of Perkin Elmer.

Measurement method: H-C-R (˜300° C.); 10.00° C./min

Chemical Resistance

1. First, the polysulfone copolymer was completely dissolved in DMAc at 25% concentration.

2. The polymer solution was casted on a support of polypropylene (PP) film in 200 μm thickness at the rate of 0.2 m/min by using an applicator and the upper portion was exposed to air at 20˜30° C. with 30˜80% humidity for about 2 minutes, and then subjected to the first desolventization in MeOH solidification bath for 3 minutes. The polysulfone (PSU) film was then peeled off from the PP support. The peeled PSU film was then immersed in H₂O solidification bath and kept therein for about 3 hours for complete desolventization, and then dried at 80° C. for 3 hours to obtain a dry PSU film.

3. The completely dried film was cut in 3 cm×3 cm size and immersed in each of 500 ml of dimethyl acetamide (DMAc), toluene and tetrahydrofuran (THF), and the degree of dissolution or swelling was observed and evaluated with a 5-point method.

Weight Average Molecular Weight (Mw) and Molecular Weight Distribution (MWD)

The measurement was made by using Gel Permeation Chromatography (Waters 2690, PL) at the temperature of 40° C. and the flow rate of 1 ml/min (Standard: polystyrene).

TABLE 4

| | Glass transition temperature (Tg) (° C.) |
|---|---|
| Example 1 | 191.9 |
| Example 2 | 194.9 |
| Example 3 | 196.5 |
| Example 4 | 204.9 |
| Example 5 | 211.9 |
| Example 6 | 218.3 |
| Example 7 | 230.1 |
| Example 8 | 225.1 |
| Example 9 | 223.4 |
| Example 10 | 224.3 |
| Example 11 | 222.5 |
| Comparative Example 1 | 190 |
| Comparative Example 2 | 189 |

TABLE 5

| | DMAc | Toluene | THF |
|---|---|---|---|
| Example 1 | 5 | 4 | 4 |
| Example 2 | 5 | 3 | 3 |
| Example 3 | 4 | 1 | 3 |
| Example 4 | 4 | 1 | 2 |
| Example 5 | 4 | 1 | 2 |
| Example 6 | 4 | 1 | 2 |
| Example 7 | 1 | 1 | 1 |
| Example 8 | 1 | 1 | 1 |
| Example 9 | 1 | 1 | 1 |
| Example 10 | 1 | 1 | 1 |
| Example 11 | 1 | 1 | 1 |
| Comparative Example 1 | 5 | 5 | 5 |
| Comparative Example 2 | 5 | 5 | 5 |

5: Very well dissolved,
4: Well dissolved,
3: Poorly dissolved,
2: Swollen,
1: Undissolved

TABLE 6

| | Weight average | Molecular weight |
|---|---|---|
| | molecular weight (Mw) | distribution (MWD) |
| Example 1 | 52,000 | 3.5 |
| Example 2 | 53,000 | 3.6 |
| Example 3 | 57,000 | 3.8 |
| Example 4 | 51,000 | 3.4 |
| Example 5 | 50,000 | 3.4 |
| Example 6 | 47,000 | 3.2 |
| Example 7 | 43,000 | 3.0 |
| Example 8 | 45,000 | 3.1 |
| Example 9 | 48,000 | 3.3 |
| Example 10 | 46,000 | 3.2 |
| Example 11 | 47,000 | 3.2 |
| Comparative Example 1 | 55,000~65,000 | 3.2~3.8 |
| Comparative Example 2 | 50,000~60,000 | 3.8~4.2 |

From Tables 4 to 6 above, it can be known that, as compared with Comparative Examples 1 and 2 having similar weight average molecular weight and molecular weight distribution, the polysulfone copolymer of the present invention showed good heat resistance indicated by the increase of glass transition temperature (Tg) as the ISB content increased, and good chemical resistance in the experiments with DMAc, toluene and THF solvents. Therefore, as compared with the conventional polysulfone copolymers of Comparative Examples, the polysulfone copolymer of the present invention has significantly improved heat resistance and chemical resistance, and thus can be suitably used for molded resin articles such as membranes, etc. In addition, since the polysulfone copolymer of the present invention comprises anhydrosugar alcohol which is a biogenic material, it can solve the problem of exhaustion of petroleum resources which are limited resource, and it does not emit carbon dioxide when disposed after use, and thus is environmentally friendly.

1. A polysulfone copolymer comprising:
repeat units derived from diol component comprising anhydrosugar alcohol; and
repeat units derived from dihalogenated sulfone compound.

2. The polysulfone copolymer according to claim 1, wherein the anhydrosugar alcohol is selected from the group consisting of isosorbide, isomannide, isoidide and mixtures thereof.

3. The polysulfone copolymer according to claim 1, wherein the diol component further comprises diol compound other than the anhydrosugar alcohol.

4. The polysulfone copolymer according to claim 3, wherein the diol compound other than the anhydrosugar alcohol is aromatic diol, alicyclic diol, aliphatic diol or mixture thereof.

5. The polysulfone copolymer according to claim 4, wherein
the aromatic diol is selected from the group consisting of bisphenol A, 4,4′-dihydroxy-diphenyl sulfone, 4,4′-biphenol, hydroquinone, 4,4′-dihydroxy-diphenylether, 3-(4-hydroxyphenoxy)phenol, bis(4-hydroxyphenyl)sulfide and combinations thereof,
the alicyclic diol is selected from the group consisting of 1,4-cyclohexanedimethanol, 1,3-cyclohexanedimethanol, 1,2-cyclohexanedimethanol, tricyclodecanedimethanol, adamantanediol, pentacyclopentadecanedimethanol and combinations thereof, and
the aliphatic diol is selected from the group consisting of ethyleneglycol, 1,3-propanediol, 1,2-propanediol, 1,4-butanediol, 1,3-butanediol, 1,2-butanediol, 1,5-heptanediol, 1,6-hexanediol, 1,4-cyclohexanedimethanol and combinations thereof.

6. The polysulfone copolymer according to claim 1, wherein the diol component may comprises, based on 100 mol % of the total diol component, 0.1 to 99 mol % of the anhydrosugar alcohol, and 1 to 99.9 mol % of diol compound other than the anhydrosugar alcohol.

7. The polysulfone copolymer according to claim 1, wherein the dihalogenated sulfone compound is selected from the group consisting of 4,4′-dichlorodiphenylsulfone, 4,4′-difluorodiphenylsulfone and combination thereof.

8. A method for preparing a polysulfone copolymer, comprising the steps of:
(1) polymerizing diol component comprising anhydrosugar alcohol, and dihalogenated sulfone compound in the presence of alkali metal salt catalyst;
(2) diluting the polymerization reaction product and removing halogenated product of alkali metal therefrom; and
(3) precipitating the diluted polymerization reaction product and washing it.

9. The method for preparing a polysulfone copolymer according to claim 8, wherein the alkali metal salt catalyst is selected from the group consisting of potassium carbonate, sodium carbonate, sodium hydroxide, potassium hydroxide and mixtures thereof.

10. A molded product manufactured by using the polysulfone copolymer of claim 1.

11. The molded product according to claim 10, which is a membrane.
